(19) United States
(12) Patent Application Publication
(10) Pub. No.: US 2002/0192378 A1
(43) Pub. Date: Dec. 19, 2002

(54) Method of hydraulic transfer, article produced by hydraulic transfer, and coating composition for hydraulic transfer

(76) Inventors: Nobuyuki Hori, Shimizu-shi (JP); Seiichi Yamamoto, Kitakatushika-gun (JP)

Correspondence Address: Joseph J Corso, Pearne & Gordon, Suite 1200, 526 Superior Avenue East, Cleveland, OH, 44114-1484, US

(21) Appl. No.: 09/958,521

(22) PCT Filed: Feb. 22, 2001
(86) PCT No.: PCT/JP01/01291

(30) Foreign Application Priority Data
Feb. 24, 2000 (JP) 2000-47367

(51) Int. Cl. B05D 5/00; B05D 1/36; B05D 1/18

(52) U.S. Cl. 427/256; 427/430.1; 427/407.1

(57) ABSTRACT

On a print pattern (12T) transferred on an objective body (34) under a liquid pressure is formed an intermediate coat layer (42) containing a binder resin of a graft copolymer comprising two unsaturation group containing vinyl monomers having respective glass transition temperatures different from each other and then a protection coat layer (46) containing at least one of an acrylic polyol resin having a hydroxyl value of 10-200 mgKOH/g and a polyester polyol resin having a hydroxyl group of 10-400 mgKOH/g.

### DESCRIPTION

A liquid pressure pattern transfer method, a liquid pressure transferred article and coating material for liquid pressure pattern transfer

### TECHNICAL FIELD

This invention pertains to a method of transferring a print pattern on various articles (objective bodies) such as metal articles, plastic moulds, ceramic articles and so on, a liquid pressure transfer article produced by this method and a coating material used for the liquid pressure pattern transfer method, and more particularly a method of suitably transferring a print pattern on such objective bodies as car panels, which will be used under severe atmospheres of temperature, humidity and so on, a liquid pressure transfer article produced by this method and a coating material suitably used for the liquid pressure pattern transfer method.

### TECHNICAL BACKGROUND

A so-called liquid pressure pattern transfer method has been used for printing various patterns on an objective body having a complicated surface configuration of roughness or the like, but not a plane surface configuration. This liquid pressure pattern transfer method is one in which a pattern transfer film of liquid soluble or liquid swelling material having a predetermined print pattern of no liquid solubility is floated on a liquid surface within a transfer bath while being sequentially supplied thereto and is made swelled by the liquid and then the objective body is immersed into the liquid within the transfer bath in a manner faced to the pattern transfer film so that the print pattern on the pattern transfer film is transferred onto the objective body by using the liquid pressure.

Since the print pattern on the pattern transfer film is in the dried and solid state, an ink of the print pattern is required to be activated by coating an activator on the print pattern so that tackiness is restored before the liquid pattern transfer is made. This activation operation is made either before the pattern transfer enters the transfer bath or after the pattern transfer film enters the transfer bath and is floated on liquid surface within the transfer bath. In general, the activator used for the activation operation comprises a binder resin imparting adhesion to the ink of the print pattern and a plasticizer imparting extensive or drawing property to a solvent and the ink (see JP8-2388987 or JP8-238898).

In case that the objective body is formed of a non-polyolefin resin such as ABS resin, polycarbonate resin, vinyl chloride or acrylic resin, the print pattern can be attached to the objective body in a good condition even though the print pattern is activated in a conventional manner, but in case that the objective body is formed of a polyolefin resin such as polyethylene or polypropylene, it is difficult to attach to the objective body the print pattern activated in a conventional manner because it has poor adhesion to the polyolefin resin. To avoid this, various treatments such as primer treatment, ultraviolet ray radiation, corona discharge or the like have been made to the objective body before the print pattern is transferred thereto.

Of late, there has been a method in which the print pattern can be transferred onto the objective body of polyolefin resin without any primary treatment (see JP9-1996).

In this method, an activator including a binder resin of a chlorinated polyolefin having a hydrophilic component imparted thereto is used for activating the print pattern on the pattern transfer film. With the aforementioned activator, the chlorinated polyolefin of the activator added to the ink when the print pattern is activated imparts good adhesion of the ink to the objective body of polyolefin resin and therefore the print pattern is adhered to the objective body in a good condition.

Conventionally, in order to impart chemical resistance and weather resistance to the print pattern transferred to the objective body or provide good appearance thereto, a protection coat layer or top coat layer is applied to the objective body so as to cover the print pattern. In the prior art, the protection coat layer is formed by coating an urethane or acrylic coat material (see paragraph number 30 of JP9-1996). However, even though the print pattern has high adhesion imparted to the objective body of polyolefin resin by activating the print pattern by using the aforementioned method, the urethane or acrylic protection coat layer has poor adhesion to the objective body and the print pattern and therefore the predetermined adhesion strength of the print pattern cannot be maintained even immediately after it is coated and dried. Also, since the poor adhesion strength is further lowered as time elapses, the protection coat layer tends to rise so as to be removed out of the surface of the objective body, which cannot protect the print pattern and deteriorates the appearance of the objective body.

Particularly, in case that the objective body such as inner or outer panel of a car is used in an outdoor atmosphere having a severe condition of humidity or temperature, both of the high adhesion of the print pattern to the objective body and the high adhesion of the protection coat layer to the objective body and the print pattern are required, but the prior protection coat layer cannot meet such requirements.

Accordingly, a principal object of the invention is to provide a method of transferring a print pattern to an objective body under a liquid pressure in which a protection coat layer as well as a print pattern (a transferred pattern) activated by an activator including a binder resin of chlorinated polyolefin and transferred onto the objective body can be solidly adhered to the objective body whereby the print pattern can be effectively protected for a longer time while it has an appearance arranged.

It is another object of the invention is to provide a liquid pressure pattern transfer article in which a protection coat layer as well as a print pattern (a transferred pattern) activated by an activator including a binder resin of chlorinated polyolefin and transferred onto the objective body can be solidly adhered to the objective body whereby the print pattern can be effectively protected for a longer time while it has an appearance arranged.

It is further object of the invention to provide a coating material used for transferring a print pattern onto an objective body in which a protection coat layer as well as a print pattern (a transferred pattern) activated by an activator including a binder resin of chlorinated polyolefin and transferred onto the objective body can be solidly adhered to the objective body whereby the print pattern can be effectively protected for a longer time while it has an appearance arranged.

### DISCLOSURE OF THE INVENTION

A fundamental method of the invention is a method of transferring a print pattern on an objective body under a liquid pressure comprising the steps of floating on a liquid surface a pattern transfer film having a print pattern activated by an activator, transferring the print pattern on the pattern transfer film onto the objective body under a liquid pressure produced by immersing the objective body below the liquid surface into the liquid while the objective body is faced to the pattern transfer film and then forming a protection coat layer on the objective body having the print pattern transferred, characterized by the activator to activate the print pattern containing a binder resin formed of a chlorinated polyolefin having a hydrophilic component imparted thereto and the protection coat layer being formed on the objective body with an intermediate coat layer placed between the objective body and the protection coat layer and having adhesion to all of the objective body, the print pattern thereon and the protection coat layer.

A concrete method of the invention is a method of transferring a print pattern on an objective body under a liquid pressure comprising the steps of floating on a liquid surface a pattern transfer film having a print pattern activated by an activator, transferring the print pattern on the pattern transfer film onto the objective body under a liquid pressure produced by immersing the objective body below the liquid surface into the liquid while the objective body is faced to the pattern transfer film and then forming a protection coat layer on the objective body having the print pattern transferred, characterized by the activator to activate the print pattern containing a binder resin formed of a graft copolymer comprising an alkoxy • (poly)alkylene-glycol • mono (metha) acrylate of 5 through 50 weight %, a chlorinated polypropylene resin of 5 through 50 weight % and a polymerized unsaturation group containing vinyl compound of 90 weight % or less than and the protection coat layer being formed on the objective body with an intermediate coat layer placed between the objective body and the protection coat layer and having adhesion to all of the objective body, the print pattern thereon and the protection coat layer.

In the liquid pressure pattern transfer method of the invention, the intermediate coat layer may preferably contains a binder resin of a graft copolymer comprising an unsaturation group containing vinyl monomer of 5 through 95 weight % having a homopolymer glass transition temperature of 50° C. or more than an unsaturation group containing vinyl monomer of 50 weight % or less than having a homopolymer glass transition temperature of less than 50° C. and a chlorinated polypropylene resin of 1 through 50 weight %.

In the liquid pressure pattern transfer method of the invention, the protection coat layer may preferably include at least one of an acrylic polyol resin having a hydroxyl value of 10-200 mgKOH/g and a polyester polyol resin having a hydroxyl value of 10-400 mgKOH/g.

In the liquid pressure pattern transfer method of the invention, with the intermediate coat layer including the binder resin of the graft copolymer comprising the unsaturation group containing vinyl monomer of 5 through 95 weight % having the homopolymer glass transition temperature of 50° C. or more thank the unsaturation group containing vinyl monomer of 50 or less weight % having the homopolymer glass transition temperature of less than 50° C. and the chlorinated polypropylene resin of 1 through 50 weight % and with the protection coat layer including at least one of the acrylic polyol resin having the hydroxyl value of 10-200 mgKOH/g and the polyester polyol resin having the hydroxyl value of 10-400 mgKOH/g, these coat layers mutually act and therefore the protection coat layer of good quality can be formed.

The invention also provides a liquid pressure pattern transferred article characterized by being produced by the liquid pressure pattern transfer method according to either of the first and second aspects The invention further provides a liquid pressure pattern transferring coating material used for the liquid pressure pattern transfer method, characterized by including a coating component to form an intermediate coat layer containing a binder resin of a graft copolymer comprising an unsaturation group containing vinyl monomer of 5 through 95 weight % having a homopolymer glass transition temperature of 50° C. or more thank an unsaturation group containing vinyl monomer of 50 weight % or less than having a homopolymer glass transition temperature of less than 50° C. and a chlorinated polypropylene resin of 1 through 50 weight %.

The liquid pressure pattern transferring coating material of the invention is characterized by including a coating component to form a protection coat layer including at least one of an acrylic polyol resin having a hydroxyl value of 10-200 mgKOH/g and a polyester polyol resin having a hydroxyl value of 10-400 mgKOH/g.

In this manner, with the protection coat layer covering the print pattern transferred onto the objective body after activated by the activator containing the binder resin formed of the chlorinated polyolefin having the hydrophilic component added thereto and being formed on the objective body with the intermediate coat layer placed between the objective body and the protection coat layer and having adhesion to all of the objective body, the print pattern thereon and the protection coat layer, the protection coat layer and the print (transfer) pattern will be never removed out of the objective body of polyolefin and therefore the protection coat layer can maintain the chemical resistance, the weather resistance and the good appearance imparted to the objective body for a longer time.

Especially, with the print pattern on the objective body activated by the activator containing the binder resin formed of the graft copolymer comprising the alkoxy • (poly)alkylene-glycol • mono (metha) acrylate of 5 through 50 weight %, the chlorinated polypropylene resin of 5 through 50 weight % and the polymerized unsaturation group containing vinyl compound of 90 weight % or less than, the chlorinated polypropylene resin in the activator enables the print pattern to be transferred onto the objective body while having higher adhesion thereto without any disarrangement of the pattern.

In addition thereto, with the intermediate coat layer containing the binder resin of the graft copolymer comprising the unsaturation group containing vinyl monomer of 5 through 95 weight % having the homopolymer glass transition temperature of 50° C. or more thank the unsaturation group containing vinyl monomer of 50 weight % or less than having the homopolymer glass transition temperature of less than 50° C. and the chlorinated polypropylene resin of 1 through 50 weight % and with the protection coat layer including at least one of the acrylic polyol resin having the hydroxyl value of 10-200 mgKOH/g and the polyester polyol resin having the hydroxyl value of 10-400 mgKOH/g, the protection coat layer having the chemical resistance, the weather resistance and the good appearance of the objective body can be adhered with the higher adhesion to both of the print pattern transferred onto the objective body after activated by the activator containing the binder resin formed of the chlorinated polyolefin having the hydrophilic component added thereto and the objective body of polyolefin.

More particularly, the chlorinated polypropylene resin in the intermediate coat layer causes the intermediate coat layer to have the higher adhesion to both of the print patter treated by the activator including the chlorinated polypropylene resin and the objective body having the print pattern transferred thereon and the protection coat layer adjusts aggregation force or cohesion force of such a degree as never damages both of the print (transfer) pattern transferred to the objective body after treated by the activator including the chlorinated polypropylene resin having not so much aggregation force and the intermediate coat layer including the chlorinated polyolefin resin whereby the chemical resistance, the weather resistance and the good appearance of the protection coat layer can be arranged.

Why the graft copolymer as the binder resin among the coating components of the intermediate coat layer comprises the unsaturation group containing vinyl monomers of different glass transition temperatures Tg is used is to maintain the appropriate aggregation force (strength) and the appropriate tackiness (adhesion) in good balance.

More particularly, the aggregation force imparts the strength to the coat layer while the tackiness imparts the adhesion (deformation follow) thereto. As the binder resin of the intermediate coat layer having the stronger aggregation force in order to improve the strength thereof, the coat layer is shrunk because of the strength leading to the hardness of the chemical bondage. This causes a crack of the coat layer and an increase in stress of the upper and lower coat layers. Although the tackiness improves the adhesion and the followability of the coat layer, the strength and the tackiness of the intermediate coat layer should be balanced relative to the print pattern adhered to the objective body after activated by the activator including the chlorinated polyolefin and placed under the intermediate coat layer and also relative to the protection coat layer placed on the intermediate coat layer. The strength and the tackiness of the binder resin of the intermediate coat layer can be balanced by using ones having the glass transition temperature different from each other.

### BRIEF DESCRIPTION OF THE DRAWINGS

FIG. 1A illustrates the step of activating a print pattern on a pattern transfer film by coating an activator on the print pattern; FIG. 1B illustrates the step of feeding to a transfer area the pattern transfer film having the print pattern activated; FIG. 1C illustrates the step of immersing an objective body into a liquid together with the pattern transfer film and transferring the print pattern onto the objective body; FIG. 1D illustrates the condition of the objective body having the print pattern transferred from the pattern transfer film in this manner; FIG. 2A illustrates the step of coating an intermediate coat layer on the objective body of FIG. 1D; FIG. 2B illustrates the step of coating a protection coat layer on the intermediate coat layer coated on the objective body; and FIG. 3 is an enlarged cross sectional view of a portion of the liquid pressure pattern transfer article produced by the steps of FIGS. 1 and 2.

### BEST MODE FOR EMBODYING THE INVENTION

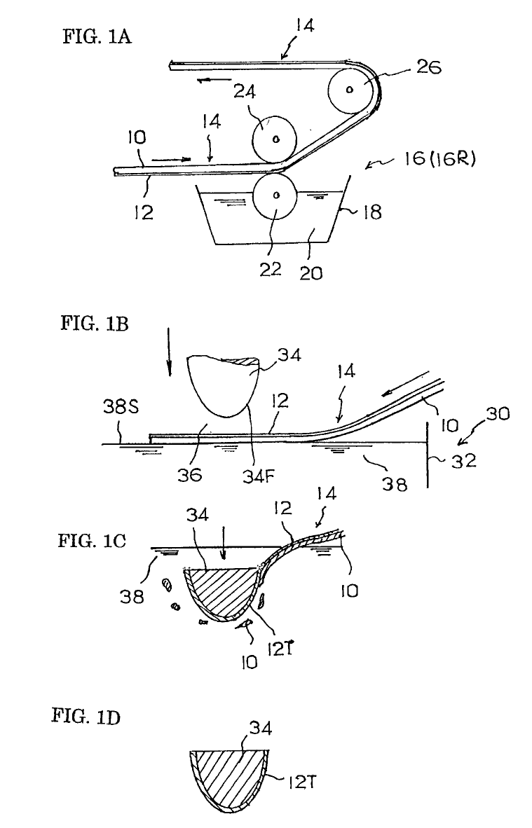

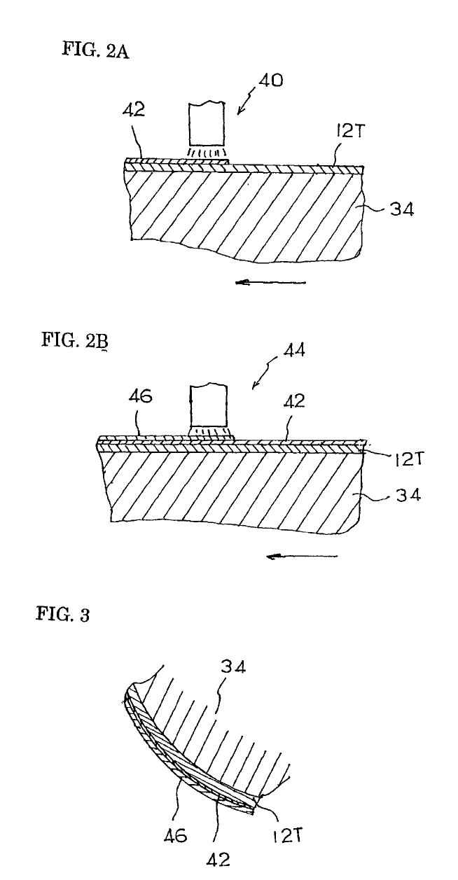

A mode of embodiment of the invention will be described hereinafter. FIG. 1 illustrates in a stepped manner the steps of embodying a liquid pressure pattern transfer method to which the invention is applied. As shown in FIG. 1A, a pattern transfer film 14 having a predetermined print pattern 12 printed on a base film 10 may be fed at predetermined velocity from a not shown film supply source to activator application means 16 such as an activator coating bath 16R, for instance. The activator coating bath 16R serves to coat an activator 20 onto the print pattern 12 on the pattern transfer film 14 being held between a coating roll 22 and a pressure roll 24 so as to attach the activator 20 to the print pattern within a bath body 18 so that the print pattern 12 is activated by the activator 20. For the activator 20 may be used one including a binder resin formed of a chlorinated polyolefin having a hydrophilic component imparted thereto as described later. As the print pattern 12 is activated, the ink of the print pattern 12 is on the state of being dissolved and being capable of being transferred.

The pattern transfer film 14 having the print pattern 12 activated in this manner is fed through a guide roll 26 shown in FIG. 1A to liquid pressure transfer means 30 shown in FIG. 1B. The liquid pressure transfer means 30 comprises a liquid pressure transfer bath 32 within which the activated pattern transfer film 14 is floated with the print pattern 12 upwardly faced. The pattern transfer film 14 is supplied at predetermined velocity to a transfer area 36 to which a transfer objective body 34 is downwardly supplied from an upper side. A liquid 38 that is typically water is filled within the transfer bath 32 and is sequentially circulated through a not shown liquid circulation apparatus including a purifier, a pump and so on. The pattern transfer film 14 is floated on the surface 38S of the liquid 38 and advanced flowing on the stream of the liquid 38 or by an appropriate transport means.

The transfer objective body 34 is immersed into the liquid 38 in the transfer area 36 with the transfer face 34F thereof being faced to the liquid surface 38S as shown in FIG. 1C. Since the pattern transfer film 14 is subject to the liquid pressure generated by the immersion of the transfer objective body 34 into the liquid, the pattern transfer film 14 is attached to the surface of the transfer objective body 34 by the liquid pressure and therefore the print pattern 12 on the pattern transfer film 14 is transferred onto the transfer face 34F of the transfer objective body 34 (see FIG. 1D). Since the base film of the pattern transfer film 14 is formed of liquid-soluble or liquid swelling materials, it is dissolved or swollen by the liquid 38 within the liquid pressure transfer bath 32 without being attached onto the objective body 34. If the base film would possibly remain attached onto the objective body 34, it would be removed out by appropriate removal means at the later step.

In the method of the invention, the objective body 34 having the print pattern (referred to as the transferred pattern 12 hereinafter) transferred in this manner passes through first coat material application (or spray) means 40 as shown in FIG. 2 to have a transparent intermediate coat layer 42 coated and then passes through second coat material application (or spray) means 44 to have a transparent or semitransparent protection coat layer 46 coated on the intermediate coat layer 42. The components of these coat layers 42 and 46 will be described in detail later.

The Fujikura Kasei Co., Ltd., one of the applicants, has proposed a method for activating the print pattern 12 for improving adhesion to the transfer objective body 34 formed of a product such as a polyolefin resin mould having poor adhesion of the print pattern from the pattern transfer film 14 and a binder resin for an activator used for the method (see JP9-19996 and JP9-76700). In this method, there is used the activator including a binder resin of a graft copolymer comprising an alkoxy (poly)alkylene-glycol•mono (metha) acrylate of 5 through 50 weight %, a chlorinated polypropylene resin of 5 through 50 weight % and a polymerized unsaturation group containing vinyl compound of 0 through 90 weight % for activating the print pattern 12.

The activator may be formed by adding an inorganic fiber and a plasticizer to the aforementioned binder resin as required and dissolving them in an appropriate organic solvent such as a toluene, xylene or the like at an appropriate weight ratio. Since the activator includes the chlorinated polypropylene, the print pattern can be attached onto the polyolefin resin product in a good manner without any surface treatment made for improving the adhesion of the print pattern to the product. Also, since the chlorinated polypropylene has the hydrophilic property imparted by being grafted with the hydrophilic alkoxy•(poly)alkylene-glycol•mono (metha) acrylate, the print pattern 12 treated by such an activator can be uniformly and sufficiently extended on the liquid (water) surface 38S within the liquid pressure (hydraulic pressure) transfer bath 32 even though the organic solvent of the activator is hydrophobic. Thus, it will be noted that the print pattern 12 can be attached onto the polyolefin resin product (objective body 34) in a satisfactory manner without any disarrangement of the pattern.

In the method of the invention, as aforementioned, the transparent intermediate coat layer 42 is coated on the objective body 34 having the transferred pattern 12T and thereafter the transparent or semitransparent protection coat layer 44 is coated on the intermediate coat layer 42. The method of the invention is characterized in that the intermediate coat layer 42 contains a binder resin of a graft copolymer comprising an unsaturation group containing vinyl monomer of 5 through 95 weight % having a homopolymer glass transition temperature of 50° C. or more than, an unsaturation group containing vinyl monomer of 60 weight % or less than having a homopolymer glass transition temperature of less than 50° C. and a chlorinated polypropylene resin of 1 through 50 weight %while the protection coat layer 44 includes at least one of an acrylic polyol resin having a hydroxyl value of 10-200 mgKOH/g and a polyester polyol resin having a hydroxyl value of 10-400 mgKOH/g.

The coating material used for the protection coat layer and including at least one of the acrylic polyol resin having the hydroxyl value of 10-200 mgKOH/g and the polyester polyol resin having the hydroxyl value of 10-400 mgKOH/g serves to maintain for a longer time the chemical resistance, the weather resistance, the physical strength and the luster which are required for the protection coat layer and which can be obtained by the bridge structure of the coating material caused by its combination with a curing agent of isocyanate or the like and to improve adhesion to the objective body. The hydroxyl value of the acrylic polyol resin or the polyester polyol resin which is the coating component for the protection coat layer should be set so as to provide the predetermined physical strength and the predetermined adhesion in a balanced manner.

More particularly, if the hydroxyl value of the acrylic polyol resin is less than 10 mgKOH/g or if the hydroxyl value of the polyester polyol resin is less than 10 mgKOH/g, the bridge density of them gets smaller, which causes the physical strength of the protection coat layer to be reduced. If the hydroxyl value of the acrylic polyol resin exceeds 200 mgKOH/g or if the hydroxyl value of the polyester polyol resin exceeds 400 mgKOH/g, the aggregation force gets larger, which causes the adhesion force of the protection coat layer to be reduced Thus, the hydroxyl value of the acrylic polyol resin is preferably of 10 through 200 mgKOH/g or the hydroxyl value of the polyester polyol resin is preferably of 10 through 400 mgKOH/g. These resins can be used for the protection coat layer while being dissolved in an appropriate solvent such as a toluene, xylene or the like.

As examples of the acrylic polyol resin having the hydroxyl value of 10 through 200 mgKOH/g for the protection coat layer may be listed ones manufactured by Toray Industries, Inc., Japan and commercially available under the trade names of COATAX LH-633, COATAX LH-635, COATAX LH-404, COATAX LH-470, COATAX LH-615 and COATAX LH-455 and ones manufactured by Dainippon Ink & Chemicals, Inc, Japan and commercially available under the trade names of ACRYDIC A-801, ACRYDIC A-812 and A ACRYDIC A-851.

As examples of the polyester polyol resin having the hydroxyl value of 10 through 400 mgKOH/g for the protection coat layer may be listed ones manufactured by Dainippon Ink & Chemicals, Inc, Japan and commercially available under the trade names of BURNOCK D-400-70, BURNOCK D-293-70, BURNOCK D-150-70 and BURNOCK J-517.

On the other hand, the intermediate coat layer 42 has the function of having the improved adhesion to both of the transfer objective body having the transferred pattern 12T and the protection coat layer 44 so that the protection coat layer 44 is not directly adhered to the transfer objective body 34. The intermediate coat layer 42 containing the binder resin of the graft copolymer comprising the unsaturation group containing vinyl monomer of 5 through 95 weight % having the homopolymer glass transition temperature of 50° C. or more than, the unsaturation group containing vinyl monomer of less than 50 weight % having the homopolymer glass transition temperature of 50° C. or less than and the chlorinated polypropylene resin of 1 through 50 weight % is suitable for the intermediate coat layer having such a function. In particular, in case that the transfer objective body is formed of the polyolefin resin and also in case that the transferred pattern 12T thereon is formed after activated by the activator including the binder resin of the chlorinated polyolefin having the hydrophilic component added thereto and transferring it on the transfer objective body, the aforementioned intermediate coat layer can accomplish the more excellent effect. The intermediate coat layer 42 can be obtained by coating the material for the intermediate coat layer formed by dissolving the aforementioned binder resin in an organic solvent such as a toluene, xylene or the like.

Since the unsaturation group containing vinyl monomers having the glass transition temperature different from each other are used as the graft copolymer of the binder resin in the coating components of the intermediate coat layer 42, the appropriate aggregation force (strength) and the appropriate tackiness force (adhesion) of the binder resin can be maintained in a balanced manner.

More particularly, if the unsaturation group containing monomer has the glass transition temperature of 50° C. or more than, the binder resin will have higher aggregation force and therefore higher strength, but it will have lower tackiness and therefore lower adhesion. If the unsaturation group containing vinyl monomer has the glass transition temperature of less than 50° C., the binder resin will have higher tackiness and therefore higher adhesion, but it will have lower aggregation force and therefore lower strength. With the binder resin of the intermediate coat layer 42 formed of the graft copolymer of both of the unsaturation group containing vinyl monomer having the glass transition temperature of 50° C. or more than and the unsaturation group containing vinyl monomer having the glass transition temperature of less than 50° C. together with chlorinated polypropylene resin, the appropriate and balanced strength and adhesion can be imparted to the intermediate coat layer.

If the unsaturation group containing vinyl monomer having the glass transition temperature of 50° C. or more than is of less than 5 weight %, then the aggregation force of the binder resin cannot be obtained and its strength is lowered and if it exceeds 95 weight %, then the adhesion is lowered. If the unsaturation group containing vinyl monomer having the glass transition temperature of less than 50° C. exceeds 50 weight %, then the aggregation force of the binder resin is lowered and therefore its strength is lowered. If the content of the chlorinated polypropylene resin is less than 1 weight %, then the adhesion is lowered and if it exceeds 50 weight %, then its strength is lowered.

As examples of the unsaturation group containing vinyl monomer having the glass transition temperature of 50° C. or more than used for the homopolymer of the intermediate coat layer are listed styrene, α-methyl styrene, vinyl toluene, methacrylic acid, methacrylic methyl, methacrylic ethyl, methacrylic tert-butyl, methacrylic cyclohexyl, isobornyl (metha) acrylate and isopentanyl methacrylate.

As examples of the unsaturation group containing vinyl monomer having the glass transition temperature of less than 50° C. used for the homopolymer of the intermediate coat layer are listed methyl acrylate, ethyl acrylate, butyl acrylate, (metha) acrylic acid 2-ethylhexyl, methacrylic acid n-butyl, methacrylic iso-butyl, lauryl (metha) acrylate and phenoxyethyl acrylate.

As examples of the chlorinated polypropylene resin to get the copolymer together with these unsaturation group containing vinyl monomers may be listed SUPERCHLON 892L, SUPERCHLON 814H and SUPERCHLON HP-213 and so on manufactured by Nippon Paper Industries Co.,Ltd.

In the mode of embodiment aforementioned, the intermediate coat layer 42 and the protection coat layer 44 are described and illustrated to be formed by coating the coating materials by the spray coating process, but they may be formed by any other suitable processes such as a gravure coating process, roll coating process, a curtain flow coating process or the likes.

The concrete compositions of the intermediate coat layer 42 and the protection coat layer 44 used by the method of the invention will be described hereinafter.

Describing an example of a method of producing the binder resin for the intermediate coat layer, respective components of the composition (A) indicated in Table I were prepared in a four-port flask of 1 liter provided with an agitator, a cooler and a monomer dropper. The components were heated until it reaches an inner temperature of 90° C. while the agitator is operated and held at 90 ° C. for 20 minutes. Thereafter, the monomers of the compositions (B) were dropped into the components in an hour and half and after they were dropped, the components of the composition (C) were added thereto. Then, the components (A) through (C) were held at 90° C. for three hours until they were polymerized to produce the copolymer resin solution. Thereafter, the copolymer resin solution was diluted in a toluene to produce the coating materials for the intermediate coat layer. In Table I, the content of the components are indicated by weight parts.

TABLE I

| KIND OF RESIN | V1 | V2 | V3 |
|---|---|---|---|
| Composition (A) | | | |
| Chlorinated PP(*1) | 150 | 500 | — |
| Chlorinated PP(*2) | — | — | 340 |
| Polymerization Initiator(*3) | 1 | 1 | 1 |
| Toluene | 100 | — | 100 |
| Composition(B) | | | |
| MMA(*4) | 325 | 200 | 80 |
| IBXA(*5) | 75 | 50 | 20 |
| 1- BMA(*6) | 20 | 45 | 60 |
| 2- EHA(*7) | 50 | 105 | 140 |
| Polymerization Initiator(*8) | 1 | 1 | 1 |
| Polymerization Initiator(*3) | 2 | 2 | 2 |
| Toluene | 180 | — | 100 |
| Composition (C) | | | |
| Polymerization Initiator(*3) | 1 | 1 | 1 |
| Toluene | 4 | 4 | 4 |
| Diluent (Toluene) | 100 | 100 | 100 |
| Nonvolatile component (%) | 50 | 50 | 50 |

(*1)Chlorinated polypropylene resin (the trade name of SUPERCHLON 892L, chlorination rate of 20%, 20% toluene solution) manufactured by Nippon Paper Industries Co., Ltd.
(*2)Chlorinated polypropylene resin (the trade name of SUPERCHLON 814H, chlorination rate of 41%, 60% toluene solution) manufactured by Nippon Paper Industries Co., Ltd.
(*3)t-butyloxy-2-ethylhexanoate
(*4)methyl methacrylate
(*5)isobornyl acrylate
(*6)iso-butyl methacrylate
(*7)2-ethylhexyl acrylate
(*8)azo-bis-isobutylonitrile

As aforementioned, the coating material for the protection coat layer may be prepared by containing the acrylic polyol resin having the hydroxyl value of 10 through 200 mgKOH/g manufactured by Toray Industries, Inc., Japan and commercially available under the trade names of COATAX LH-633, COATAX LH-635, COATAX LH-404, COATAX LH-470, COATAX LH-615 and COATAX LH-455 or manufactured by Dainippon Ink & Chemicals, Inc, Japan and commercially available under the trade names of ACRYDIC A-801, ACRYDIC A-812 and ACRYDIC A-851 or the polyester polyol resin having the hydroxyl value of 10 through 400 mgKOH/g manufactured by Dainippon Ink & Chemicals, Inc, Japan and commercially available under the trade names of BURNOCK D-400-70, BURNOCK D-293-70, BURNOCK D-150-70 and BURNOCK J-517. For instance, the acrylic polyol resin having the hydroxyl value of 70 mgKOH/g commercially available under the trade name PG9940 manufactured by the Fuzikura Kasei Co., Ltd and the polyester polyol resin having the hydroxyl value of 150 mgKOH/g commercially available under the trade name PG9941 manufactured by the Fuzikura Kasei Co., Ltd may be used. The coating materials can be formed by combining the main agent of PG940A-N of 30 weight parts, the curing agent of PG9940B-N2 of 5 weight parts and the thinner of PG9940C-11 of 12 weight parts or by combining the main agent of PG941A-N of 100 weight parts, the curing agent of PG9941B of 25 weight parts and the thinner of PG9941CS-1 of 20 weight parts.

Some examples of the invention will be described with respect to the transfer objective body, the activator for activating the print pattern on the transfer film and the components of the intermediate and protection coat layers which were used for the liquid pressure transfer method of the invention.

### EXAMPLE 1

In order to activate the print pattern on the transfer film as shown in FIG. 1A, the activator was used which was formed of the binder resin of the trade name PG2799L of 30 weight parts manufactured by Fujikura Kasei Co., Ltd., the DBP (dibutyl phthalate) of 15 weight parts, butyl carbitol acetate of 45 weight parts and the xylene of 10 weight parts. After the print pattern was activated by coating the activator on the print pattern on the transfer film, the print pattern was transferred onto the transfer objective body of the polypropylene resin product by the method as shown in FIGS. 1B through 1D. After the transfer objective body was dried, the intermediate and protection coat layers were formed by the spray coating process shown in FIGS. 2A and 2B.

The intermediate coat layer was formed by coating the coating material obtained by further diluting the copolymer resin solution V1 of 10 weight parts indicated in the Table I with the toluene of 90 weight parts so that the dried layer thickness was 5-15 μm. The protection coat layer was formed by coating the material of the trade name PG9940 manufactured by Fujikura Kasei Co., Ltd. and containing the acrylic polyol resin having the hydroxyl value of 70 mgKOH/g so that the dried layer thickness was 10-40 μm. The activator was applied using a printing body having an application amount of 14-15 g/m2.

### EXAMPLE 2

The liquid pressure pattern transfer was made and the coat layers were formed in the manner identical to the Example 1 except for using the copolymer resin solution V2 of the Table I as the binder resin of the intermediate coat layer.

### EXAMPLE 3

The liquid pressure pattern transfer was made and the coat layers were formed in the manner identical to the Example 1 except for using the copolymer resin solution V3 of the Table I as the binder resin of the intermediate coat layer.

### COMPARISON 1

The protection coat layer was formed without any intermediate coat layer directly on the polyolefin objective body having the transfer pattern transferred from the transfer film having the print pattern activated by the conventional activator containing no chlorinated polypropylene and the conventional activator was used which contained no binder resin of chlorinated polyolefin having the hydrophilic component imparted thereto and the protection coat layer was formed by coating the coating materials of the trade name PG9940 manufactured by Fujikura Kasei Co., Ltd and identical to those used in EXAMPLE 1.

### COMPARISON 2

After the generally used coating materials for the polypropylene of the trade name of UNISTOLE P401 manufactured by Mitsui Chemical Co., Ltd. was coated on the polyolefm objective body having the transferred pattern obtained by transferring the print pattern from the transfer film after it was activated by the same activator as used in COMPARISON 1, the protection coat layer was formed by coating the coating material of the trade name PG9940 manufactured by Fujikura Kasei Co., Ltd and identical to those used in EXAMPLE 1.

### COMPARISON 3

After the same intermediate coat layer as used in EXAMPLE 1 was formed on the polyolefin objective body having the transferred pattern obtained by transferring the print pattern from the transfer film after it was activated by the same activator as used in EXAMPLE 1, the protection coat layer was formed by coating the coating material of the trade name PG9940 manufactured by Fujikura Kasei Co., Ltd and identical to those used in EXAMPLE 1.

### COMPARISON 4

After the conventional coating material for polypropylene of the trade name of UNISTOLE P401 manufactured by Mitsui Chemical Co., Ltd. was coated on the polyolefin objective body having the transferred pattern obtained by transferring the print pattern from the transfer film after it was activated by the same activator as used in EXAMPLE 1 to form the intermediate coat layer, the protection coat layer was formed by coating the coating material of the trade name PG9940 manufactured by Fujikura Kasei Co., Ltd and identical to those used in EXAMPLE 1.

### COMPARISON 5

The protection coat layer was formed by coating the coating material of the trade name PG9940 manufactured by Fujikura Kasei Co., Ltd and identical to those used in EXAMPLE 1, on the polyolefm objective body having the transferred pattern obtained by transferring the print pattern from the transfer film after it was activated by the same activator as used in EXAMPLE 1 without any intermediate coat layer.

### COMPARISON 6

The liquid pressure pattern transfer was made and the coat layer were formed in the manner identical to COMPARISON 5 except for using the coating material prepared by adding the copolymer resin V1 of 10 weight parts of TABLE I to the component of the trade name PG9940 of 150 weight parts manufactured by Fujikura Kasei Co., Ltd.

The compositions of the activators and the coating materials in EXAMPLES 1 through 3 and COMPARISONS 1 through 6 are as in TABLE II.

TABLE II

| | | INTERMEDIATE | PROTECTION |
|---|---|---|---|
| | ACTIVATOR | COAT LAYER | COAT LAYER |
| EXAMPLE 1 | Af | PCv1 | TCf |
| EXAMPLE 2 | Af | PCv2 | TCf |
| EXAMPLE 3 | Af | PCv3 | TCf |
| COMPARISON 1 | Ap | — | TCf |
| COMPARISON 2 | Ap | PCp | TCf |
| COMPARISON 3 | Ap | PCv1 | TCf |
| COMPARISON 4 | Af | PCp | TCf |
| COMPARISON 5 | Af | — | TCf |
| COMPARISON 6 | Af | — | TCf + V1 |

“Af”: Activator comprising the binder resin commercially available under the trade name of PG2799L of 30 weight parts manufactured by Fujikura Kasei Co., Ltd., DBP (dibutyl phthalate) of 15 weight parts, butyl carbitol acetate of 45 weight parts and the xylene of 10 weight parts.

“Ap”: Conventional activator (containing no binder resin formed of chlorinated polyolefin having the hydrophilic component imparted thereto)

“PCv1”: Coating material obtained by dissolving the binder resin V1 of 10 weight parts of Table I in the toluene of 90 weight parts.

“PCv2”: Coating material obtained by dissolving the binder resin V2 of 10 weight parts of Table I in the toluene of 90 weight parts.

“PCv3”: Coating materials obtained by dissolving the binder resin V3 of 10 weight parts of Table I in the toluene of 90 weight parts.

“PCp”: Coating material of the trade name of UNISTOLE P401 manufactured by Mitsui Chemicals Co., Ltd. (Generally used polypropylene coat material)

“TCf”: Coating materials of the trade name PG9940 manufactured by Fujikura Kasei Co., Ltd.

The results obtained by estimating the appearance, the initial adhesion state and the secondary adhesion state of the objective bodies (the liquid pressure transfer articles) produced by Examples 1 through 3 and Comparisons 1 through 6 are as shown in Table III. In the estimation, the appearance was estimated using the symbols of ο indicating the value of 90 or more than obtained by determining the appearance of the articles relative to the 60° luster given by the measurement by the gloss meter, Δ indicating the value of 80 to 90 and X indicating the value of less 80. The initial adhesion state is one obtained by measuring the adhesion condition immediately after the protection coat layer was formed while the secondary adhesion is one obtained by measuring the adhesion condition after the waterproof test of the formed protection coat layer for 24 hours at 40° C. or the moisture resistance test of the formed protection coat layer under the humidity of 95% for 500 hours at 50° C. was made. The adhesion state was measured by the adhesion test (gap of 1 mm and square number of 100) according to the “8.5.1 cross-cut adhesion tape method” of JIS (Japan Industrial Standard)-K5400. The adhesion states were estimated using the symbols of ο indicating that no evidence of removal of the protection coat layer was found, Δ indicating that removal of 1/100 or more than and less than 10/100 of the protection coat layer was found and χ indicating that removal of 10/100 or more than of the protection coat layer was found.

TABLE III

| | | INITIAL | SECONDARY |
|---|---|---|---|
| | | ADHESION | ADEHESION |
| | APPEARANCE | STATE | STATE |
| EXAMPLE 1 | ∘ | ∘ | ∘ |
| EXAMPLE 1 | ∘ | ∘ | ∘ |
| EXAMPLE 1 | ∘ | ∘ | ∘ |
| COMPARISON 1 | ∘ | x | x |
| COMPARISON 2 | ∘ | x | x |
| COMPARISON 3 | ∘ | x | x |
| COMPARISON 4 | ∘ | Δ | x |
| COMPARISON 5 | ∘ | x | x |
| COMPARISON 6 | x | Δ | Δ |

As apparent from Table III, in Examples 1 through 3 in which the intermediate coat layer contained the binder resin of the graft copolymer comprising the unsaturation group containing vinyl monomer of 5 through 95 having the homopolymer glass transition temperature of 50° C. or more thank the unsaturation group containing vinyl monomer of 50 weight % or less than having the homopolymer glass transition temperature of less than 50° C. and the chlorinated polypropylene resin of 1 through 50 weight % and the protection coat layer included at least one of the acrylic polyol resin having the hydroxyl value of 10-200 mgKOH/g and the polyester polyol resin having the hydroxyl value of 10-400 mgKOH/g, all of the appearance, the initial adhesion state and the secondary adhesion state of the protection coat layer were good and therefore it will be noted that good adhesion state of the improved protection coat layer and the improved printed or transferred pattern on the polyolefin objective body could be maintained for a longer time.

On the other hand, in Comparisons 1 and 2 in which the prior art activator containing no chlorinated polypropylene was used, in Comparisons 5 and 6 in which the intermediate coat layer was not applied or in Comparison 4 in which the intermediate coat layer contained no graft copolymer comprising the two unsaturation group containing vinyl monomer having the glass transition temperature different from each other and the chlorinated polyolefin resin, even though, in all the Comparisons, the protection coat layer containing the acrylic polyol resin having the hydroxyl value of 10-200 mgKOH/g or the polyester polyol resin having the hydroxyl value of 10-400 mgKOH/g was used, it will be noted that the appearance (Comparison 6), the initial adhesion state (Comparisons 1 through 6) and the secondary adhesion state (Comparisons 1 through 6) were poor. Especially, it will be noted that the method other than that of the invention cannot be suitable for the objective bodies such as inner or outer panels for cars used outdoors under the severe atmospheres of temperature, humidity and so on and required to have the high adhesion state of the protection coat layer.

According to the invention, as aforementioned, since the protection coat layer covering the print pattern transferred onto the objective body after activated by the activator containing the binder resin of the chlorinated polyolefin having the hydrophilic component added thereto is formed on the objective body with the intermediate coat layer placed between the objective body and the protection coat layer and having the adhesion to all of the objective body, the print pattern thereon and the protection coat layer, the printed or transferred pattern, the intermediate coat layer and the protection coat layer are never removed out of the objective body of polyolefin and therefore the protection coat layer can have the good appearance arranged and can maintain the chemical resistance and the weather resistance for a longer time.

Especially, with the print pattern on the objective body activated by the activator containing the binder resin formed of the graft copolymer comprising an alkoxy•(poly)alkylene-glycol•mono (metha) acrylate of 5 through 50 weight %, the chlorinated polypropylene resin of 5 through 50 weight % and the polymerized unsaturation group containing vinyl compound of 90 weight % or less than, the chlorinated polypropylene resin in the activator enables the print pattern to be transferred onto the objective body of polyolefin resin product while having the improved adhesion thereto without any disarrangement of the pattern, and in addition thereto, with the intermediate coat layer including the binder resin of the graft copolymer comprising the unsaturation group containing vinyl monomer of 5 through 95 weight % having the homopolymer glass transition temperature of 50° C. or more than, the unsaturation group containing vinyl monomer of 50 weight % or less than having the homopolymer glass transition temperature of less than 50° C. and the chlorinated polypropylene resin of 1 through 50 weight % and with the protection coat layer including at least one of the acrylic polyol resin having the hydroxyl value of 10-200 mgKOH/g and the polyester polyol resin having the hydroxyl value of 10-400 mgKOH/g, the protection coat layer can be adhered with the higher adhesion to both of the print pattern transferred onto the objective body while activated by the activator containing the binder resin of the chlorinated polyolefin having the hydrophilic component added thereto and the polyolefin objective body and therefore the protection coat layer can have the good appearance arranged and can maintain the chemical resistance and the weather resistance for a longer time.

The liquid pressure pattern transfer article having the intermediate coat layer including the binder resin of the graft copolymer which comprises the unsaturation group containing vinyl monomer of 5 through 95 weight % having the homopolymer glass transition temperature of 50° C. or more than, the unsaturation group containing vinyl monomer of 50 weight % or less than having the homopolymer glass transition temperature of less than 50° C. and the chlorinated polypropylene resin of 1 through 50 weight % and the protection coat layer including at least one of the acrylic polyol resin having the hydroxyl value of 10-200 mgKOH/g and the polyester polyol resin having the hydroxyl value of 10-400 mgKOH/g can have the good appearance arranged by the protection coat layer and can have the chemical resistance and the weather resistance maintained for a longer time.

The coating material for the intermediate coat layer including the binder resin of the graft copolymer which comprises the unsaturation group containing vinyl monomer of 5 through 95 weight % having the homopolymer glass transition temperature of 50° C. or more thank the unsaturation group containing vinyl monomer of 50 weight % or less than having the homopolymer glass transition temperature of less than 50° C. and the chlorinated polypropylene resin of 1 through 50 weight % and the coating material for the protection coat layer including at least one of the acrylic polyol resin having the hydroxyl value of 10-200 mgKOH/g and the polyester polyol resin having the hydroxyl value of 10-400 mgKOH/g can serve to solidly adhere the transferred pattern and the coating materials themselves to the objective body and therefore they are suitable for producing the liquid pressure pattern transfer article having the good appearance arranged by the protection coat layer and can have the transferred pattern maintained for a longer time.

### UTILIZABILITY OF INDUSTRIES

As aforementioned, the method according to the invention can suitably maintain the print pattern transferred on the surface of the objective body such as the car panel, which will be used under severe atmosphere of temperature, humidity and so on.

1. A method of transferring a print pattern on an objective body under a liquid pressure comprising the steps of floating on a liquid surface a pattern transfer film having a print pattern activated by an activator, transferring said print pattern on said pattern transfer film onto said objective body under said liquid pressure produced by immersing said objective body below said liquid surface into the liquid while said objective body is faced to said pattern transfer film and then forming a protection coat layer on said objective body having said print pattern transferred, characterized by said activator to activate said print pattern containing a binder resin formed of a chlorinated polyolefin having a hydrophilic component imparted thereto and said protection coat layer being formed on said objective body with an intermediate coat layer placed between said objective body and said protection coat layer and having adhesion to all of said objective body, said print pattern thereon and said protection coat layer.

2. A method of transferring a print pattern on an objective body under a liquid pressure comprising the steps of floating on a liquid surface a pattern transfer film having a print pattern activated by an activator, transferring said print pattern on said pattern transfer film onto said objective body under said liquid pressure produced by immersing said objective body below said liquid surface into the liquid while said objective body is faced to said pattern transfer film and then forming a protection coat layer on said objective body having said print pattern transferred, characterized by said activator to activate said print pattern containing a binder resin formed of a graft copolymer comprising an alkoxy•(poly)alkylene-glycol•mono (metha) acrylate of 5 through 50 weight %, a chlorinated polypropylene resin of 5 through 50 weight % and a polymerized unsaturation group containing vinyl compound of 90 weight % or less than and said protection coat layer being formed on said objective body with an intermediate coat layer placed between said objective body and said protection coat layer and having adhesion to all of said objective body, said print pattern thereon and said protection coat layer.

3. A method of transferring a print pattern on an objective body under a liquid pressure as set forth in claim 1 or 2, and wherein said intermediate coat layer contains a binder resin of a graft copolymer comprising an unsaturation group containing vinyl monomer of 5 through 95 weight % having a homopolymer glass transition temperature of 50° C. or more thank an unsaturation group containing vinyl monomer of 50 weight % or less than having a homopolymer glass transition temperature of less than 50° C. and a chlorinated polypropylene resin of 1 through 50 weight %.

4. A method of transferring a print pattern on an objective body under a liquid pressure as set forth in claim 1 or 2, and wherein said intermediate coat layer contains a binder resin of a graft copolymer comprising an unsaturation group containing vinyl monomer of 5 through 95 weight % having a homopolymer glass transition temperature of 50° C. or more thank an unsaturation group containing vinyl monomer of 50 weight % or less than having a homopolymer glass transition temperature of less than 50° C. and a chlorinated polypropylene resin of 1 through 50 weight % and wherein said protection coat layer including at least one of an acrylic polyol resin having a hydroxyl value of 10-200 mgKOH/g and a polyester polyol resin having a hydroxyl value of 10-400 mgKOH/g.

5. A liquid pressure pattern transferred article characterized by either of the methods as set forth in claims 1 through 4.

6. A liquid pressure pattern transferring coating material to be used or the liquid pressure pattern transfer method as set forth in claim 1 or 2 including a coating component to form an intermediate coat layer containing a binder resin of a graft copolymer comprising an unsaturation group containing vinyl monomer of 5 through 95 weight % having a homopolymer glass transition temperature of 50° C. or more thank an unsaturation group containing vinyl monomer of 50 weight % or less than having a homopolymer glass transition temperature of less than 50 ° C. and a chlorinated polypropylene resin of 1 through 50 weight %.

7. A liquid pressure pattern transferring coating material to be used for the liquid pressure pattern transfer method as set forth in claim 1 or 2 including a coating component to form an intermediate coat layer containing a binder resin of a graft copolymer comprising an unsaturation group containing vinyl monomer of 5 through 95 weight % having a homopolymer glass transition temperature of 50° C. or more thank an unsaturation group containing vinyl monomer of 50 weight % or less than having a homopolymer glass transition temperature of less than 50° C. and a chlorinated polypropylene resin of 1 through 50 weight % and including a coating component to form a protection coat layer containing at least one of an acrylic polyol resin having a hydroxyl value of 10-200 mgKOH/g and a polyester polyol resin having a hydroxyl value of 10-400 mgKOH/g.
